(19) United States
(12) Patent Application Publication
(10) Pub. No.: US 2007/0251601 A1
(43) Pub. Date: Nov. 1, 2007

(54) Drum chipper and method providing for air cooling

(76) Inventor: Bradley R. Stager, Beaverton, OR (US)

Correspondence Address: BIRDWELL & JANKE, LLP, 1100 SW SIXTH AVENUE, SUITE 1400, PORTLAND, OR, 97204, US

(21) Appl. No.: 11/415,591

(22) Filed: May 1, 2006

(51) Int. Cl. B27L 11/00

(52) U.S. Cl. 144/373

(57) ABSTRACT

A drum chipper and method providing for air cooling. A drum member, a knife, and a carrier for mounting the knife to the drum member are provided. The carrier comprises an upper clamping member and a lower clamping member for clamping the knife therebetween. The carrier is adapted to mount to the drum member at axially spaced apart mounting positions thereon. The apparatus is advantageously used to chip heat sensitive materials, such as plastic, particularly where the carrier is spaced above and unsupported by the drum member over a span defined between the mounting positions to provide for airflow between the drum member and the carrier.

### FIELD OF THE INVENTION

The present invention relates to improvements in a drum chipper providing for air cooling, which is advantageous for chipping, pulverizing or granulating heat sensitive materials such as plastic.

### BACKGROUND

Drum chippers are commonly used in the wood processing industry to reduce the size of logs by removing chips or flakes for the purpose of shaping the log for subsequent finish processing into lumber. However, drum chippers are also often employed for processing waste wood materials to produce the chips themselves, which are used in the manufacture of engineered board products, such as oriented strand board, pulp and paper. For this latter purpose, it is commercially important to produce chips having defined quality characteristics.

The cutting head of the drum chipper has an elongate, cylindrical shape, and has a plurality of correspondingly elongate knives mounted on the cylindrical surface. The cutting head spins about its cylindrical axis. Compared to disc chippers where the knives are disposed on the periphery of the disc, the elongate knives of the drum chipper provide for cutting a relatively large surface area.

The cutting head, particularly the knives, become heated as a result of chipping work, and some of this heat is transferred to the material being worked. For chipping wood, this heating is not generally sufficient to significantly change the chipping dynamics. However, a hot cutting head can transfer enough heat to a material that is heat sensitive, such as plastic, to degrade chipping performance. This can be readily appreciated by thinking about the extreme case where the cutting head transfers enough heat to the material being chipped to melt or bum it. Thus, for chipping some materials, such as plastic, it is important to provide for cooling the cutting head.

Such cooling is typically provided by the use of open spaces between the knives and the cutting head. As the cutting head spins, air is able to flow around the knife through the spaces and, by convection, carry away much of the heat generated at the knives.

FIG. 1 shows a prior art drum chipper cutting head 2 utilizing this cooling methodology. Elongate knives 4 are supported at mounting positions 6; between which there are open spaces 5 under the knives, between the knives and the cutting head, through which air can flow as a result of spinning the head 2 about an axis of rotation “L.” The knife spans across the mounting positions, like a bridge.

The knives are unsupported by the cutting edge over their spans, so that they are as a result of this configuration much more susceptible to deformation in response to chipping forces. Accordingly, it is important that the knives be able to function as structural members as well as cutting members. To resist bending over the length of their spans, the knives must have sufficient bulk.

The required bulk of the knives raises the material cost of the knives. And since the knives are more costly, they are more costly to dispose of, which makes it more important to repair the knives and less economically practical to replace the knives when their cutting edges wear. Removing and replacing a knife is more difficult when it is heavy, and repairing the knife requires additional labor as well as the acquisition, repair, maintenance and storage of costly equipment.

Accordingly, there is a need for a drum chipper and method providing for air cooling that eliminates these and other disadvantages of the prior art.

### SUMMARY

A drum chipper and method providing for air cooling. A basic apparatus comprises a drum member, a knife, and a carrier for mounting the knife to the drum member. The carrier comprises an upper clamping member and a lower clamping member for clamping the knife therebetween. The carrier is adapted to mount to the drum member at axially spaced apart mounting positions thereon.

In a preferred method, the basic apparatus is used to chip plastic material.

In a preferred apparatus, the carrier is spaced above and unsupported by the drum member over a span defined between the mounting positions to provide for airflow between the drum member and the carrier.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is pictorial view of a prior art drum chipper providing for air cooling.

FIG. 2 is a pictorial view of a drum chipper providing for air cooling according to the present invention, showing a carrier according to the invention exploded.

FIG. 3 is an exploded view of the carrier of FIG. 2.

FIG. 4 is a side elevation of the carrier of FIG. 2.

FIG. 5 is an end elevation of the carrier of FIG. 4.

FIG. 6 is a cross-sectional view of the carrier of FIG. 4, taken along a line 6-6 thereof.

FIG. 7 is a cross-sectional view of the carrier of FIG. 4, taken along a line 7-7 therof.

FIG. 8 is a front-side, pictorial view of a preferred knife for use in the carrier of FIG. 2.

FIG. 9 is a back-side, pictorial view of the knife of FIG. 8.

FIG. 10 is an end elevation of the knife of FIGS. 8 and 9.

FIG. 11 is a plan view of the drum chipper of FIG. 2.

### DETAILED DESCRIPTION OF PREFERRED EMBODIMENTS

Reference will now be made in detail to specific preferred embodiments of the invention, examples of which are illustrated in the accompanying drawings.

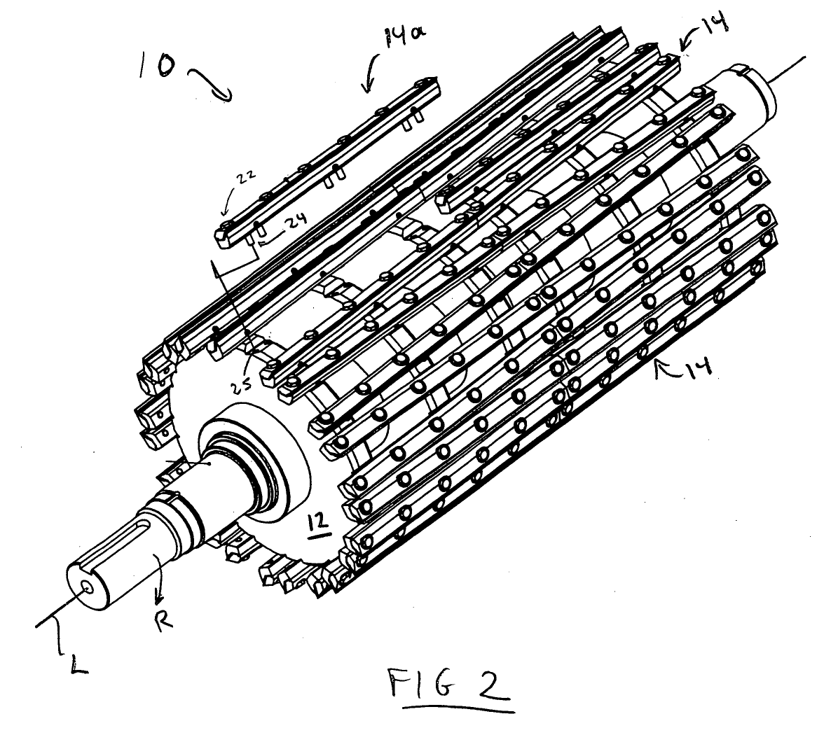

FIG. 2 illustrates a preferred drum chipper 10 according to the invention. The drum chipper 10 includes an elongate drum member 12 that rotates about an axis of rotation “L.” A drum member as used herein is substantially or essentially cylindrical or drum-shaped as known in the art for this class of apparatus, and the axis of rotation L is an elongate axis of the drum member. Mounted to the drum member 12 are a number of knife carriers 14.

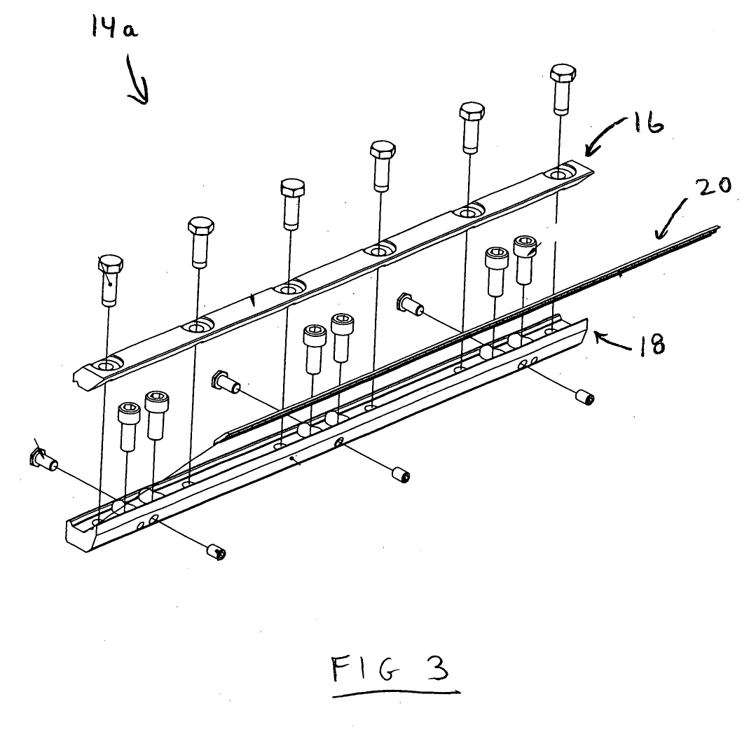

One of the knife carriers 14, namely the carrier 14a, is shown exploded from the drum member. The carrier 14a is shown in more detail in FIG. 3, which shows some constituent parts of the carrier exploded. Each carrier 14 includes an upper clamping member 16 and a lower clamping member 18 for clamping a knife 20 therebetween.

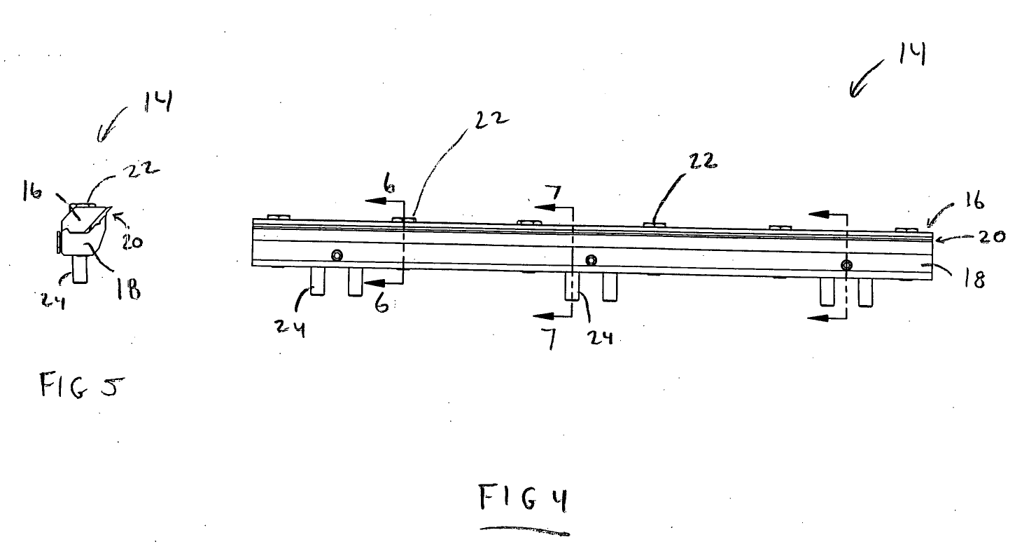

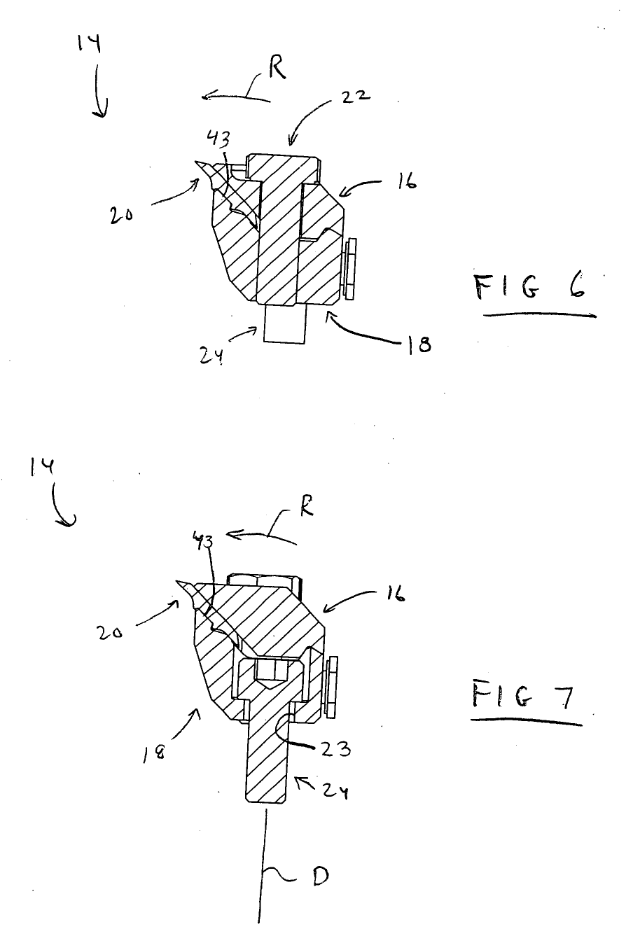

A knife carrier 14 is shown assembled in FIGS. 4 and 5, with the knife 20 clamped between the upper and lower clamping members 16 and 18. FIGS. 6 and 7 are cross-sectional views of the carrier. FIG. 6 shows the cross-section indicated in FIG. 4 as 6-6, taken through a clamping bolt 22 that extends through the upper clamping member 16 into the lower clamping member 18, where it is received in a threaded hole (not shown). The clamping bolts 22 clamp the knife in the carrier.

FIG. 7 shows the cross-section of the knife carrier 14 indicated in FIG. 4 as 7-7, taken through mounting bolts 24 that extend through carrier mounting bolt holes 23 in the lower clamping member 18 into threaded carrier mounting bolt holes 25 in the drum member as shown in FIG. 2. The mounting bolt holes 25 are preferably aligned in radial directions “D” (FIG. 7), i.e., directions perpendicular to the axis L of the drum member 12 (FIG. 2). The mounting bolts 24 mount the carrier 14 to the drum member.

Returning to FIG. 2, explosion of the knife carrier 14a reveals the manner in which the carriers 14 are mounted to the drum member 12. That is, the carrier mounting bolt holes 25 in the drum member are provided in circumferentially disposed, axially-spaced apart, projecting rings 26 that project above the surface 27 of the drum member 12. The projection of the rings above the surface 27 raises the carriers 14 above the surface over the axial distance or “span” defined between adjacent rings 26. Space that lies axially between the rings 26, and radially between the surface 27 of the drum member 12 and one of the carriers 14, is an open space through which air can flow and cool the carrier by convection produced by the spinning motion of the drum member.

It is an outstanding advantage of the knife carrier that it completely eliminates the requirement for the knife itself to provide the structural rigidity necessary to span the open spaces. The knife may therefore be optimized for the single purpose of cutting, and can be formed of a minimal amount of material for this purpose. Thence it becomes economically feasible, due to the decreased material costs of the knife, to simply dispose of the knife once the cutting edge wears.

The carrier, on the other hand, has a wear rate that is much less than that of the knife. Therefore, making the carrier as bulky and sturdy as is required to perform the function of supporting the knife does not impose nearly the same penalties that providing this function in the knife itself imposes.

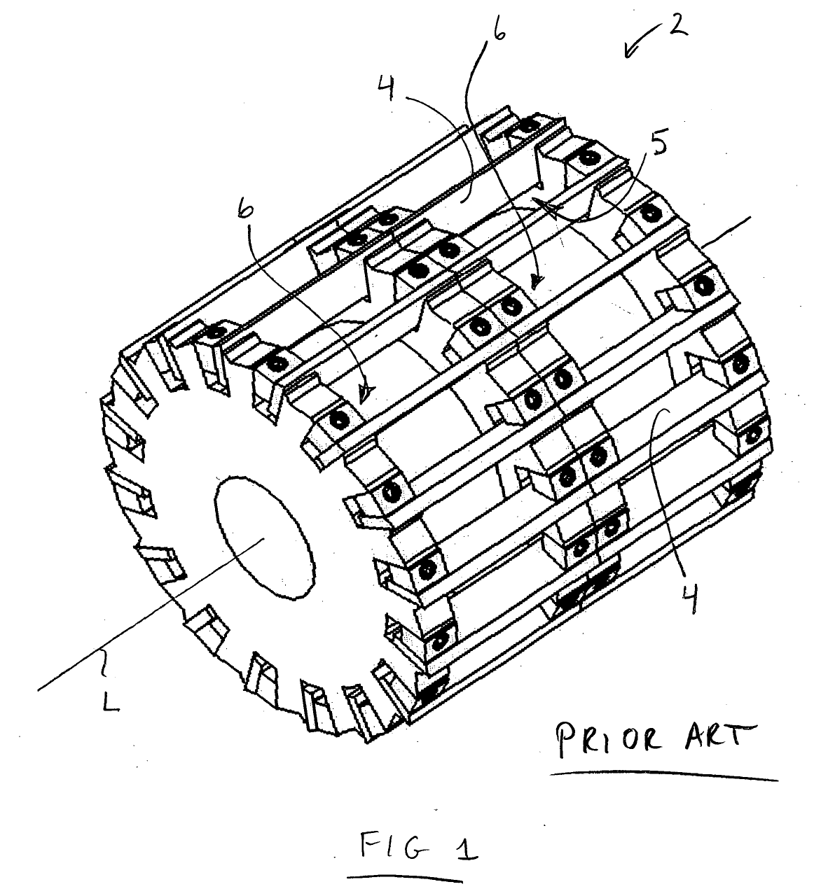

In providing for a physically smaller knife, the carrier provides for decreased shipping, storage, and handling costs associated with the knife in addition to decreased material and manufacturing costs for the knife. Moreover, the knife can be made narrow enough that it need not be turned on its side and wedged into pockets in the rings as shown in FIG. 1 to accommodate the desired number of knives. The mounting bolts 24 and radially directed carrier mounting holes 25 described above provide for maximum strength and simplicity of mounting the carrier, and therefore the knife, to the drum. In addition, the manufacturing cost of the drum may be reduced as compared to the prior art by eliminating the need to machine pockets.

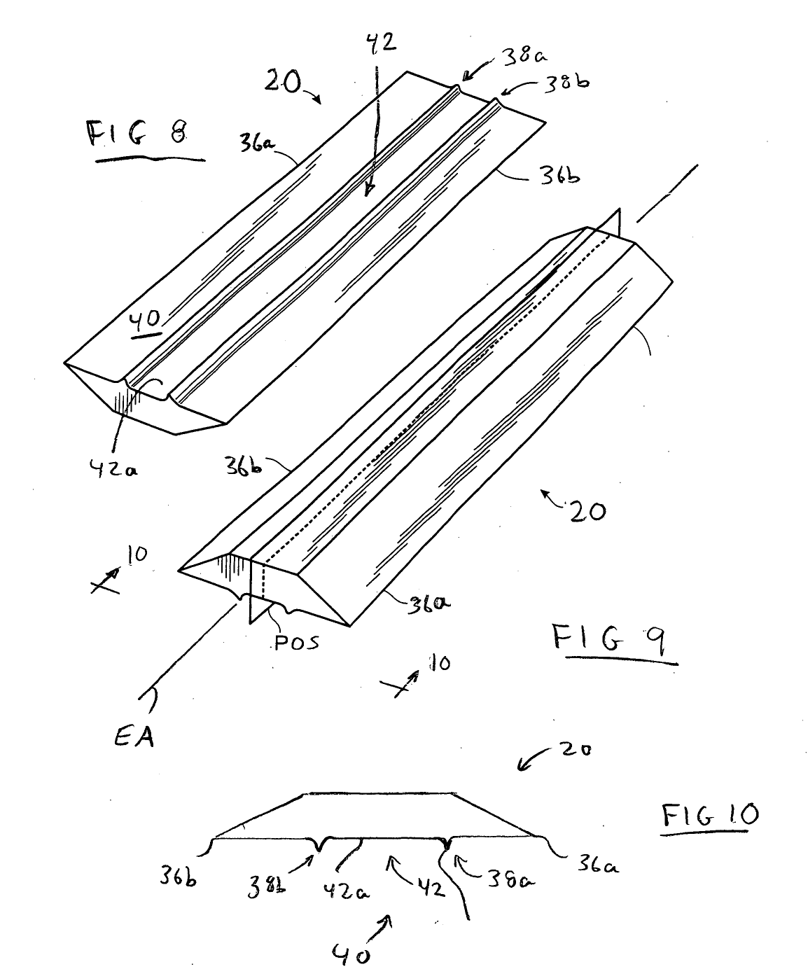

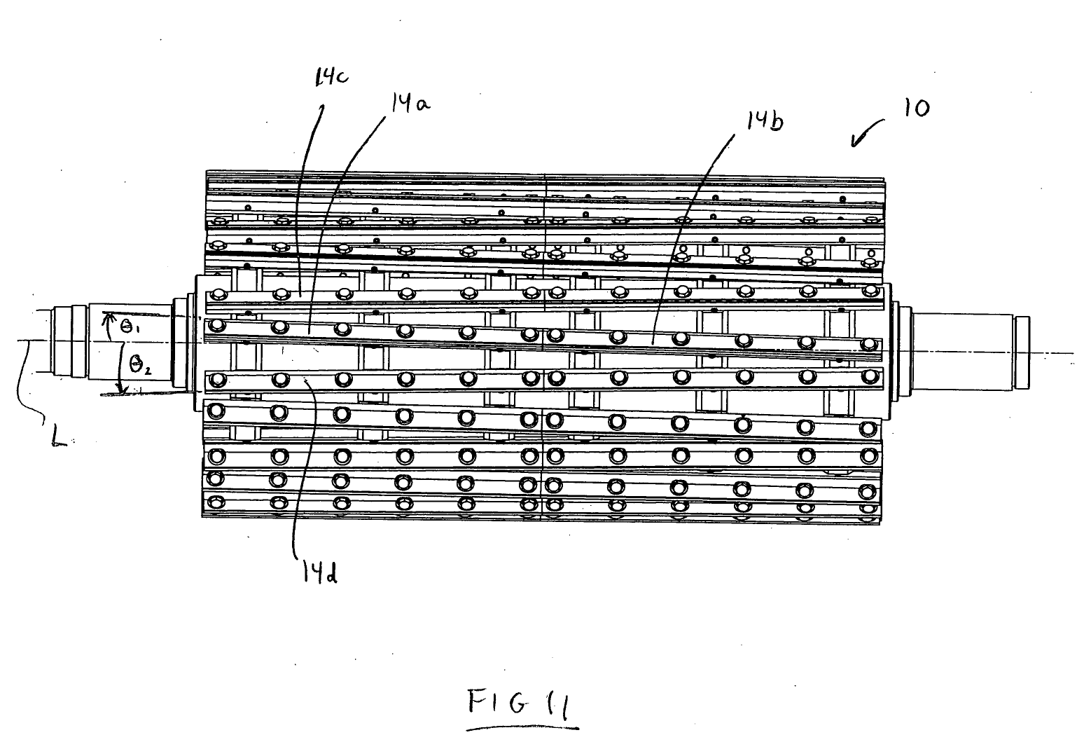

With reference to FIGS. 8-10 showing particularly the knife 20, in furtherance of providing for a maximal amount of cutting from a substrate of minimal physical size and weight, the knives 20 are preferably provided with dual, opposed, cutting edges 36a and 36b and corresponding deflector ridges 38a and 38b such as described in Schmatjen, U.S. Pat. No. 5,819,826 that project from a front side 40 of the knife that faces in the direction of rotation “R” of the drum member 12 (FIGS. 2, 6 and 7). The deflector ridges and the cutting edges are all parallel to an elongate axis “EA” of the knife 20. The deflector ridges define points “E” of maximum projection from the front side 40 defining a single line or edge.

The knife is symmetric about a plane of reflective symmetry “POS.”

The deflector ridges define a channel 42 having a channel surface 42a. The channel 42 is effectively a recess in the front side of the knife, which may be provided by other features, such as a keyway. A back surface 44 of the knife 20 is received by the upper clamping member 16.

The recess provided, in the preferred embodiment, by the deflector ridges 38 and the associated channel 42 define an interlocking feature adapted for interlocking with a toe portion 43 of the lower clamping member 18 (FIGS. 6 and 7), providing a double-sided, indexable knife system that securely and positively holds the knife in the carrier. Particularly, as seen in FIGS. 4 and 5, the lower clamping member 18 is adapted so that one of the deflector ridges 38a is disposed outside a toe 39 of the lower clamping member at one end of the toe, the other end of the toe being defined by a recess 41 shaped to receive the other deflector ridge 38b.

Turning to FIG. 11, the carrier 14a as mounted to the drum member 12 is axially adjacent another carrier, namely 14b. The carriers 14a and 14b function for purposes of the present invention as a single carrier running the entire axial length of the drum member. It is unimportant for present purposes whether carriers are provided in axially adjacent segments or not.

The knife carrier 14a as mounted to the drum member 12 is circumferentially, or azimuthally, adjacent two carriers, namely 14c, on the one side of the carrier 14a, and 14d, on the other side of the carrier 14a. The carrier 14a is not parallel to either of the adjacent carriers 14c and 14d, but the carriers 14c and 14d on either side of the carrier 14a are parallel to each other. Moreover, none of the carriers are parallel to the axis L. The angle that the elongate axes EA of the knives 20 make with axis L is referred to as a “slicing angle.”

Providing a non-zero slicing angle progressively phases-in different points of the cutting edges of the same knife so that they come into contact with the material being cut at different times. This concentrates the cutting force at the phased-in points and reduces as well as smooths out the power requirements. Alternating the slicing angle of azimuthally adjacent carriers varies the timing between cuts made at the same axial position of the cutting head, which further smooths out the power requirements. Preferably, the slicing angle measured with respect to the axis L not only varies between azimuthally adjacent knife carriers, but alternates direction such as is shown in FIG. 11 as θ₁ and θ₂ for the azimuthally adjacent carriers 14a and 14d, respectively.

It is to be understood that, while a specific drum chipper and method providing for air cooling has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A drum chipper providing for air cooling, comprising:
a drum member;
a knife; and
a carrier comprising an upper and lower clamping member for clamping the knife therebetween, said carrier being adapted to mount to said drum member at axially spaced apart mounting positions thereon such that said carrier is spaced above and unsupported by said drum member over a span defined between said mounting positions to provide for airflow between said drum member and said carrier.

2. The drum chipper of claim 1, comprising a plurality of instances of said carrier adapted to mount to said drum member at azimuthally spaced apart positions thereon.

3. The drum chipper of claim 2, wherein adjacent instances of said carrier provide different slicing angles.

4. The drum chipper of claim 3, wherein each said instance of said carrier is adjacent, on each side thereof, a respective additional instance of said carrier, said additional instances of said carrier providing the same slicing angles.

5. The drum chipper of claim 4, wherein said carrier is adapted for indexing said knife to a predetermined disposition therein.

6. The drum chipper of claim 5, wherein said lower clamping member is disposed between said upper clamping member and said drum member, wherein said lower clamping member includes an indexing feature to provide for said indexing.

7. The drum chipper of claim 6, wherein said lower clamping member is adapted to receive a front side of said knife, and wherein said indexing feature includes at least one deflector ridge defining, at points of maximum projection from said front side, a single linear edge.

8. The drum chipper of claim 3; wherein said carrier is adapted for indexing said knife to a predetermined disposition therein.

9. The drum chipper of claim 8, wherein said lower clamping member is disposed between said upper clamping member and said drum member, wherein said lower clamping member includes an indexing feature to provide for said indexing.

10. The drum chipper of claim 9, wherein said lower clamping member is adapted to receive a front side of said knife, and wherein said indexing feature includes at least one deflector ridge defining, at points of maximum projection from said front side, a single linear edge.

11. The drum chipper of claim 2, wherein said carrier is adapted for indexing said knife to a predetermined disposition therein.

12. The drum chipper of claim 11, wherein said lower clamping member is disposed between said upper clamping member and said drum member, wherein said lower clamping member includes an indexing feature to provide for said indexing.

13. The drum chipper of claim 12, wherein said lower clamping member is adapted to receive a front side of said knife, and wherein said indexing feature includes at least one deflector ridge defining, at points of maximum projection from said front side, a single linear edge.

14. The drum chipper of claim 1, wherein said carrier is adapted for indexing said knife to a predetermined disposition therein.

15. The drum chipper of claim 14, wherein said lower clamping member is disposed between said upper clamping member and said drum member, wherein said lower clamping member includes an indexing feature to provide for said indexing.

16. The drum chipper of claim 15, wherein said lower clamping member is adapted to receive a front side of said knife, and wherein said indexing feature includes at least one deflector ridge defining, at points of maximum projection from said front side, a single linear edge.

17. The drum chipper of claim 1, farther comprising a plurality of mounting bolts and corresponding first carrier mounting bolt holes extending through said lower clamping member for receiving said mounting bolts, wherein said drum member includes associated second carrier mounting bolt holes for threadingly receiving said mounting bolts, for rigidly mounting said lower clamping member to said drum member.

18. The drum chipper of claim 17, wherein said second carrier mounting bolt holes are substantially radially aligned with respect to an axis of rotation of said drum member.

19. A method for chipping plastic material, comprising the steps of:
providing a drum chipping apparatus, comprising:
a drum member,
a knife, and
a carrier comprising an upper and lower clamping member for clamping the knife therebetween, said carrier being adapted to mount to said drum member at axially spaced apart mounting positions thereon;
rotating said drum member about an axis of rotation; and
presenting the plastic material so as to cause the knife to come into contact therewith.

20. The method of claim 19, further comprising providing said carrier spaced above and unsupported by said drum member over a span defined between said mounting positions to provide for airflow between said drum member and said carrier.

21. The method of claim 20, further comprising repairing said knife by removing said knife from said carrier while leaving at least said lower clamping member on said drum member.

22. The method of claim 19, further comprising repairing said knife by removing said knife from said carrier while leaving at least said lower clamping member on said drum member.
